(19) United States
(12) Patent Application Publication
(10) Pub. No.: US 2010/0326065 A1
(43) Pub. Date: Dec. 30, 2010

(54) HYDRAULIC POWER TRANSMISSION SYSTEM FOR A MINERAL MATERIAL PROCESSING PLANT, A METHOD FOR CONTROLLING THE SAME, A SCREENING MACHINE AND A CRUSHING MACHINE

(75) Inventors: Sami Permi, Vesilahti (FI); Toni Kujala, Tampere (FI); Mika Peltonen, Tampere (FI)

Correspondence Address: OLIFF & BERRIDGE, PLC, P.O. BOX 320850, ALEXANDRIA, VA, 22320-4850, US

(73) Assignee: METSO MINERALS INC., Helsinki (FI)

(21) Appl. No.: 12/811,763

(22) PCT Filed: Jan. 17, 2008
(86) PCT No.: PCT/FI08/50013

§ 371 Date: Aug. 30, 2010

(51) Int. Cl. F15B 11/05; F15B 11/16; B02C 25/00; B02C 23/02

(52) U.S. Cl. 60/327; 60/459; 60/422; 241/69; 241/34

(57) ABSTRACT

Hydraulic transmission system for a mineral material processing plant, which transmission system comprises at least two hydraulic first motors, which are arranged to drive at least one conveyor belonging to the mineral material processing plant, at least two first directional valves connected via the first actuator channels of the directional valves to each of the first motors, a hydraulic pump arranged to transfer hydraulic fluid via the first actuator channels of the directional valves to the first motors. The system also comprises pressure sensors. The first directional valves are valves that can be adjusted by external control during the running of the processing plant and which are arranged to control the volume flow of the hydraulic fluid supplied into the first motors. The control is made on the basis of the pressure of hydraulic fluid measured by pressure sensors in the first actuator channels the directional valves.

### FIELD OF THE INVENTION

The invention relates to a hydraulic transmission system for a mineral material processing plant according to the preamble of the appended claim 1. The invention also relates to a method for controlling a hydraulic transmission system for a mineral material processing plant according to the preamble of the appended claim 16, as well as to a screening machine according to the preamble of the appended claims 31 and a crushing machine according to the preamble of the appended claim 39.

### BACKGROUND OF THE INVENTION

The invention relates to a mineral material processing plant. In this description and the claims, a processing plant refers to any processing plant suitable for the processing of mineral materials, such as a crushing, screening or feeding machine, or a corresponding material transferring, refining or sorting device. Processing plants used for the recycling of material, such as shredders and metal separators, belong to this group as well. The material to be processed is mineral material. The mineral material can be ore, broken rock or gravel, various types of recyclable construction waste, such as concrete, bricks or asphalt. Construction waste may also contain metal; that is, they may also be, for example, reinforced concrete. The material can also be domestic waste, as well as wood, glass or metal.

Screening machines are used to separate fractions of different sizes from the feed material fed into the machine. The separation is performed by means of a screen, the size of the sieve meshes or openings in the screen deck determining the particle size of the resulting fraction. In this way, material fractions suitable for the needs of the end user are obtained. The feed materials used include soils, for example gravel, broken rock material, soil (humus) and peat, as well as various products, side products and waste from industrial processes.

An essential part of the screening machine is the screen, which may be, for example, a vibrating screen or a trommel screen. Furthermore, the screening machine comprises a power transmission apparatus, a control system, as well as devices for feeding material into and discharging it from the machine. Conveyors, such as belt conveyors, are generally used for feeding and discharging of material. The screening machines are often equipped with wheels or tracks to facilitate its movability.

The screen may comprise one or more screen decks, wherein the upper screen decks separate, from the feed material, coarse fractions with a large particle size and the lower screen decks separate fine fractions with a smaller particle size. The separation or screening is based on the fact that the screen meshes or openings are larger in the upper screen decks than in the lower screen decks. Thus, the small particles fall through the upper screen decks until they reach a screen deck that is capable of holding them, and the larger particles remain on the upper screen decks. However, the finest particles of all pass through all the screen decks. The material remaining on top of the screen decks is called the surplus of said screen deck, and the material passing through them is called the reject of said deck.

The material fractions separated by the screen are moved by conveyors away from the screening machine and from each other so that they cannot be mixed with each other after the screening. The surplus and/or reject of each screen deck is transferred by a separate conveyor.

Other material processing devices, such as a crusher, can also be connected to the screening machines. The screening machine may thus be placed as a screening unit completely separate from the crusher, solely for screening the material coming from the crusher. It is also possible to integrate a crusher in the screening machine so that the crusher crushes, for example, the surplus of the topmost screening deck to smaller particles which are returned to screening after the crushing.

Screening machines of the above-described kind are presented, for example, in patent publications WO 03/004176, which discloses a self-propelled screening machine machine mounted on tracks and comprising several screening units, U.S. Pat. No. 6,336,558, which discloses a movable screening machine mounted on wheels, and U.S. Pat. No. 6,698,594, which discloses a self-propelled screening machine mounted on tracks.

FIG. 1 shows, in a cross-sectional view, a movable screening machine 1 of prior art in the position of its use. Its main parts comprise a frame 2 that joins the actuators of the screening machine to each other. The screening machine can be moved on the support of tracks 3 provided in the lower part of the frame 2, for example by means of hydraulic pressure produced by a hydraulic pump (not shown in the figure) driven by a diesel motor 4. In the operating position, the screening machine is supported to the ground by means of support legs 5.

The actuators involved in the actual screening process include a feeder hopper 6, a feeding device, that is, a lifting conveyor 7, a lifting conveyor hopper 8, a screen 9, a distribution chute 10, a crusher 11, a return conveyor 12, a return conveyor chute 13, a first product type conveyor 14, a second product type conveyor 15, and a third product type conveyor (not shown in the figure). The product type conveyors discharge the material fractions obtained from the different screen decks of the screen on different sides of the screening machine 1: the first product type conveyor discharges the fraction 1′ conveyed by it to the rear of the screening machine, and the second and third product type conveyors discharge the fractions 2′ and 3′ conveyed by them to the sides of the screening machine, as shown in FIG. 2.

The product type conveyors are belt conveyors, of which the structure of a product type conveyor 14 will be discussed in more detail in the following. The other product type conveyors are essentially similar in structure. The product type conveyor 14 comprises a frame structure (not shown in the figure), a conveyor belt 14a which is an endless belt loop extending around the frame structure, as well as rotating drums 14b and 14c arranged in contact with the conveyor belt at both ends of the frame structure. The drum 14b is a so-called drawing drum equipped with a driving motor 22, normally a hydraulic motor, which effects the rotation of the drum around its axis. Thus, the drawing drum 14b is also used as the drum that rotates the conveyor belt. In this case, the screen is a three-deck vibrating screen, whose screen decks are indicated in the figure by the numerals 9a, 9b and 9c and whose vibrating movement is effected by a vibrator 17.

The feeding of the screening machine is effected by using, for example, a crushing machine (not shown in the figure) separate from the screening device, wherein the feed material 19 is introduced by the discharge conveyor 18 of the crushing machine via the feeder hopper 6 onto the lifting conveyor 7 which conveys the feed material into the lifting conveyor funnel 8. From there, the feed material is discharged onto the topmost screening deck 9a of the screen 9.

The feed material is screened according to its particle size by means of the screen decks 9a, 9b and 9c. The size of the meshes of the screen decks is reduced towards the lower part of the screen, wherein material is separated onto the topmost screen deck 9a of the screen, having a particle size larger than the particles separated onto the middle screen deck 9b or the lowermost screen deck 9c of the screen. In a corresponding manner, material discharged onto the middle screen deck 9b has a larger particle size than the material separated onto the lowermost screen deck 9c of the screen. The particles passing through the lowermost screen deck are the smallest of all in size. The vibrating movement of the screen effects the distribution of the material onto the surface of the screen decks 9a, 9b and 9c in the form of material mats which become thinner towards the distribution chute 10 so that only particles which are larger than the meshes of the screen deck are found on the decks at this end of the screen.

The part of the feed material that does not penetrate the topmost screen deck 9a is guided by the distribution chute 10 in the crusher 11 mounted onto the frame 2. The crusher reduces the particle size of the surplus of the screen. The material ground by the crusher falls onto the return conveyor 12 which transfers it to the return conveyor chute 13, from which the material is discharged onto the lifting conveyor 7. Thus, a so-called closed circulation is formed in which the feed material particles circulate until their grain size is sufficiently small to penetrate the topmost screen deck 9a of the screen.

The part of the feed material that passes through the topmost screen deck 9a but not the middle screen deck 9b is guided by the distribution chute 10 onto the second product type conveyor 15 which extends in its operating position to the side of the screening machine. The part of the feed material that passes through the middle screen deck 9b but not the lowermost screen deck 9c, is guided by the distribution chute 10 to the third product type conveyor (not shown in the figure) which extends to the other side of the screening machine 1, not shown in the figure. The part of the feed material that passes through even the lowermost screen deck 9c will end up on the first product type conveyor 14.

In FIG. 2, which shows the screening machine of FIG. 1 seen from above, the placement of the first 14, second 15 and third product type conveyor 16 is shown with respect to the screening machine 1.

Crushing machines are used for reducing the particle size of feed material fed into the machine. The feed material can be ore, broken rock or gravel, and various types of recyclable construction waste, such as concrete, bricks or asphalt.

The essential part of the crushing machine is the crusher, which may be, for example, a jaw crusher, a centrifugal crusher, or a gyratory and cone crusher. The crusher type is selected according to the material to be crushed and the use of the crusher. Furthermore, the crushing machine comprises a power transmission apparatus, a control system, as well as a feed conveyor for feeding material into the machine, and at least one product type conveyor for discharging the crushed material formed in the crusher. In general, the conveyors used are belt conveyors. The crushing machines are often equipped with wheels or tracks to facilitate their moving. A crusher of the above-described type is shown, for example, in the publication U.S. Pat. No. 6,402,072.

FIG. 3 shows, in a side view, a movable crushing machine 101 of prior art in the position of its use. Its main parts comprise a frame 102 that joins the actuators of the crushing machine to each other. The crushing machine can be moved on the support of tracks 103 provided in the lower part of the frame 102, for example by means of hydraulic pressure produced by a hydraulic pump (not shown in the figure) driven by a diesel engine 104.

The actuators involved in the actual crushing process are a feed conveyor 106, a feed conveyor chute 107, a crusher 108, and a product type conveyor 109. The feed and product type conveyors are belt conveyors which are substantially similar, in their structure, to the product type conveyors shown in connection with FIG. 1. Both comprise a frame structure, an endless conveyor belt extending around the frame structure, as well as rotating drums arranged in contact with the conveyor belt at both ends of the frame structure. One of the drums is a so-called drawing drum equipped with a driving motor, normally a hydraulic motor, which effects the rotation of the drum around its axis. FIG. 3 shows the drawing drum 110 of the conveyor 109, and its driving motor 111. The driving motor for the feed conveyor is indicated with the numeral 112.

The material to be crushed is fed into the feed conveyor chute 107, from which it is carried by means of the feed conveyor 106 into the crusher 108. The conveyor 109 discharges the material from the crusher, i.e. the crushed material, farther away from the crushing machine.

The transmission of the above-described mineral material processing devices, and the power transmission apparatuses used therein, are normally based on electric or hydraulic transmission. The power source is typically a diesel engine, a separate power aggregate or public power supply system.

The control of the processing devices is generally implemented by means of microprocessor based control systems that comprise a control device. The control devices are not shown in FIG. 1 or 3. Thus, at least some of the devices of the screening or crushing machine are equipped with various sensors for monitoring the operating condition of the machine and for defining control commands for the valves of the hydraulic circuits and for the switches of the electric drives. An important part of the operation of the control system is the monitoring of the condition of the machine on the basis of values given by sensors connected to the machine, for example pressure sensors in the channels conveying hydraulic fluid.

U.S. Pat. No. 5,292,006 discloses a control system for a screening machine, comprising two pumps for pumping hydraulic fluid. One of these is used as a pump for a driving motor driving a conveyor, and the other is used as a pump for the slotted screen of the screen and for the driving motors for a feeder disc. The pressure of the hydraulic fluid in the hydraulic fluid duct of the actuator for the conveyor is monitored, and if it rises too high, the flow of the hydraulic fluid into the driving motor driving the feeder disc of the screen is interrupted.

A processing device applying hydraulic transmission may have a single common hydraulic system for driving all the motors of the machine. A so-called load sensing or LS control system is generally used.

FIG. 4 shows a known hydraulic LS system for a screening machine. In this example, the screen comprises two decks, wherein three product types are produced: the material which has not passed through the upper screen deck, that is, the surplus of the upper deck; the material which has not passed through the lower deck, that is, the surplus of the lower deck; and the material that has passed both the screen decks, that is, the reject. A separate conveyor is provided for each of these product types. Furthermore, a second conveyor is provided for the surplus of the upper deck, namely a recirculation conveyor which guides the material to the crusher to be crushed again.

The hydraulic motors 22-26 rotating the different actuators of the screening machine are connected to the same hydraulic system. The first motors 22-25 drive the conveyors belonging to the screening machine, the motor 22 drives the drawing drum of the surplus conveyor of the upper deck, the motor 23 drives the drawing drum of the surplus conveyor of the lower deck, the motor 24 drives the drawing drum of the reject conveyor, and the motor 25 drives the drawing drum of the recirculation conveyor. The second motor 26 is the hydraulic motor for the screening machine unit of the screen. The hydraulic motor for the screening machine unit rotates at a constant rate. The screen itself may be either a vibrating screen or a trommel screen. The system is intended to keep the speed of the material-conveying conveyors, that is, the rotation speed of the drawing drums of the conveyors, at a predetermined constant speed value. The rotation speed of the drawing drums is determined according to the running speed of the motors connected to them.

The system comprises a pump/control block A and identical directional valve blocks B-F for each motor. The pump/control block A comprises a hydraulic pump 10, a pressure difference regulator 27 and a cylinder 28. The directional valve blocks B-F comprise on/off directional valves 29-33, pressure compensators 34-38, and shuttle valves 39-43.

A diesel engine 4 is used as a power source for the hydraulic pump 20. The hydraulic pump 20 pumps hydraulic fluid, normally hydraulic oil, from a hydraulic fluid tank 21 via the pressure channel 44 of the directional valve to the pressure compensators 34-38 and further via directional valves 29-33 and the first actuator channels 45-49 of the directional valves to first and second hydraulic motors 22-26 connected to the system.

The pump 20 produces the volume flow required by the system, which is affected by the pressure caused by the load on the drive motors. The volume flow is not measured at any point in the system. The pressure caused by the load of the conveyors or by the screen and transmitted via the second actuator channels 50-54 of the directional valves is sensed via bores in the directional valves 29-33. The highest pressure data is guided via a load sensing channel 55 to the pressure difference regulator 27 of the pump 20, which gives a control command to the cylinder 28. The cylinder 28 adjusts the output of the pump so that the pressure prevailing in the pressure channel 44 of the directional valve is about 20 bar higher than the pressure of the first or second hydraulic motor that drives the conveyor or the screening machine unit with the heaviest load. In other words, the pressure difference determined by the cylinder 28 is adjusted according to the motor with the highest pressure. The pressure difference is normally about 20 bar, but it may vary from about 15 to 30 bar. The pressure compensators 34-38 installed in the directional valve blocks B-F keep the motor-specific volume flow constant by choking the volume flow or by opening the cross-sectional area of the flow in spite of varying pressures in the pressure channel 44 and in the actuator channels, caused by the loads of any of the first or second motors 22-26. Consequently, the pressure compensators take care that the speeds of all the conveyors remain constant all the time.

As seen in the figure, the system also comprises channels and lines for transferring hydraulic fluid and pressure messages between control devices and valves, as well as other parts whose operation is known as such for a person skilled in the art, so that they will not be discussed in more detail in this context.

A problem with conventional screening machines is that the rotation speeds of the drawing drums of all the product type conveyors are adjusted according to the maximum load of the conveyors. Thus, the drawing drums rotate all the time at the speed required by the maximum load of the conveyor. However, in a practical use situation, all the conveyors are seldom, if ever, charged with the maximum load of material to be transferred simultaneously. This means that at least some of the conveyors rotate at a speed that is too high with respect to the conveying need. Such a conveyor rotating at too high a speed and charged with only a small load is also operated at too low a pressure level compared with the pressure level of the conveyors rotating simultaneously at a heavy load. This is due to the operation of the pressure compensators 34-38 which, as presented above, adjust the volume flow by choking or opening the cross-sectional area of flow when needed. This choking will cause pressure differences which are equal to the difference between the pressure prevailing in the pressure channel 44 of the directional valve at each time and the pressure required by the first or second motor 22-26. Such pressure differences cause power losses in the load sensing system.

The power losses increase the diesel fuel consumption of the diesel engine. Furthermore, if a crusher is connected to the screening machine, it is normally driven by the same diesel engine as the conveyors are. The extra power and in this case unnecessarily high power required by the conveyors is lacking from the crusher and may, in a situation of maximum loading of the crusher, be a significant negative factor affecting its operation.

Moreover, the hydraulic pump of the system must be dimensioned according to the actuators of the system, that is, in this case, to be too large with respect to the real need. The rotating of the conveyors in vain at their maximum speed will also cause an unnecessary need for cooling of the hydraulic system.

In the crushing machine, in principle the same quantity of material is discharged from the crusher onto the product conveyor as is fed by the feed conveyor into the crusher. However, momentary variations take place in the material quantities, wherein at least some of the conveyors rotate at a speed that is too high with respect to the conveying need. This causes power losses in the load sensing system.

### BRIEF SUMMARY OF THE INVENTION

It is thus an aim of the present invention to provide a hydraulic transmission system for a mineral material processing plant, whereby the above-mentioned problems can be avoided and power savings can be achieved by adjusting the speed of the conveyors connected to the processing plant, which power can be used elsewhere in the process.

To attain this purpose, the hydraulic transmission system according to the invention is primarily characterized in what will be presented in the characterizing part of the independent claim 1.

The method according to the invention, in turn, is primarily characterized in what will be presented in the characterizing part of the independent claim 16.

The screening machine according to the invention, in turn, is primarily characterized in what will be presented in the characterizing part of the independent claim 31.

The crushing machine according to the invention, in turn, is primarily characterized in what will be presented in the characterizing part of the independent claim 39.

The other, dependent claims will present some preferred embodiments of the invention.

The invention is based on the idea that the rotation speeds of all the conveyors belonging to the mineral material processing device are adjusted according to the respective load of the conveyors. In other words, when the load of a conveyor, that is, the quantity of material to be conveyed on the conveyor, is changed, the rotation speed of the conveyor is adjusted accordingly. The load of the conveyor is measured by measuring the pressure of the hydraulic fluid supplied into the hydraulic motor of the conveyor by means of a pressure sensor, and if the pressure rises, the rotation speed of the conveyor is increased. In a corresponding manner, if the pressure drops, the rotation speed of the conveyor is reduced. In this way, the conveyors can be driven at a speed that is as low as possible but still sufficient with respect to the load of the conveyor, and the pressure differences between the different conveyors can be kept small.

The adjustment of the rotation speed of the conveyors is made by adjusting the volume flow of hydraulic fluid supplied into the hydraulic motor of each conveyor by means of directional valves installed in the system. The directional valves are valves that can be adjusted by external control and which can be controlled, for example, electronically. The valves may be, for example, proportional directional valves or servo valves. For each conveyor motor, one directional valve is provided which changes the volume flow supplied to the respective motor.

The pressure of the hydraulic fluid is measured by a pressure sensor connected to the first actuator channel of the directional valve, the channel connecting the directional valve and the motor. There is thus one pressure sensor for each of said channels. The measurement result of the pressure sensor is transferred to a control unit which monitors the pressure levels of the conveyors and uses them to generate control messages according to the pressure levels, which control messages are sent to the respective directional valve.

The control can be implemented in the form of continuous control during the run of the process. Thus, measurements and control measures based on them are taken regularly, at certain intervals. The control can also be implemented so that the measurements and control measures are taken intermittently, when needed in the process.

Thanks to the invention, significant power savings are achieved, as the pressure differences between the conveyors can be kept small and the volume flows are reduced. The diesel engine power saved in this way can be utilized elsewhere in the apparatus. In the case of a screening machine or a crusher, the saved power can be used, for example, in a crusher connected to a screening machine, wherein its crushing result is improved. Furthermore, it is unnecessary to overdimension the components, for example the hydraulic pump or even the diesel engine.

Moreover, the fuel consumption of the diesel engine and the exhaust gas emissions into the environment are reduced. In some cases, it is even possible to use a smaller diesel engine as a power source, which brings considerable savings in the investment costs of the processing device. Furthermore, the oversizing of the hydraulic pump is avoided, wherein in some cases it is possible to use a smaller pump. A smaller hydraulic pump will require less cooling capacity; thus, the pump used for cooling can be smaller as well. Furthermore, the diagnostics of the device is improved, thanks to the increased number of measurement points.

### BRIEF DESCRIPTION OF THE DRAWINGS

In the following, the invention will be described in more detail with reference to the appended drawings, in which

FIG. 1 shows, in a side view and in a partial cross section, a movable screening machine of prior art mounted on tracks, in which the invention can be applied,

FIG. 2 shows schematically the screening machine of FIG. 1 seen from above,

FIG. 3 shows, in a schematical side view, a movable screening machine of prior art mounted on tracks, in which the invention can be applied,

FIG. 4 shows schematically a hydraulic transmission system according to prior art,

FIG. 5 shows schematically a hydraulic transmission system according to the invention, and

FIG. 6 shows schematically another hydraulic transmission system according to the invention.

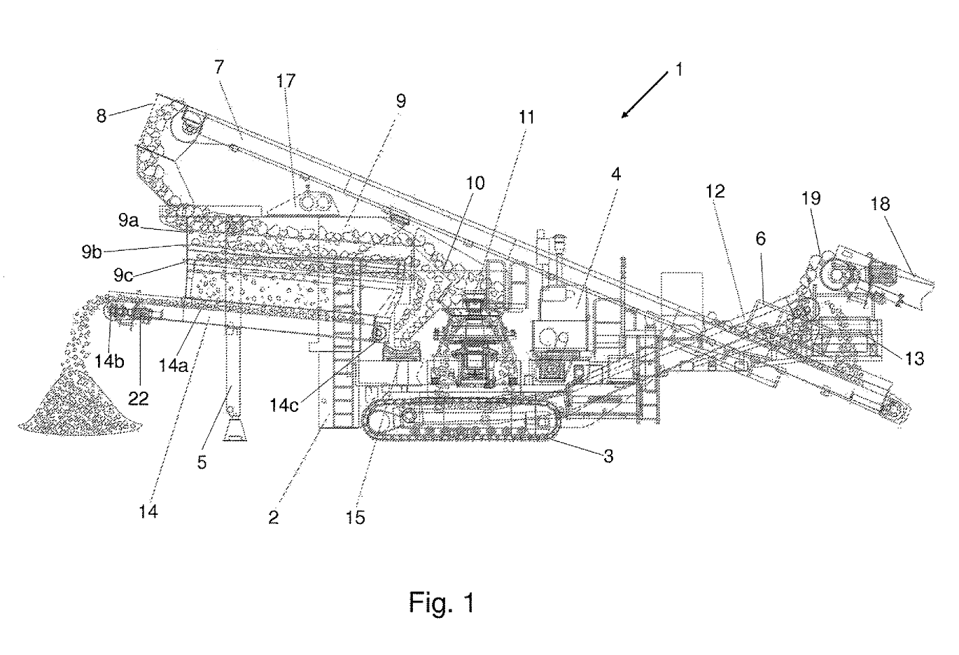

In FIGS. 1 to 6, the same numerals refer to corresponding parts and they will not be explained separately later on, unless required for the illustration of the subject matter.

### DETAILED DESCRIPTION OF THE INVENTION

FIGS. 1 to 4 were already described above, for which reason they will not be discussed any more in this context.

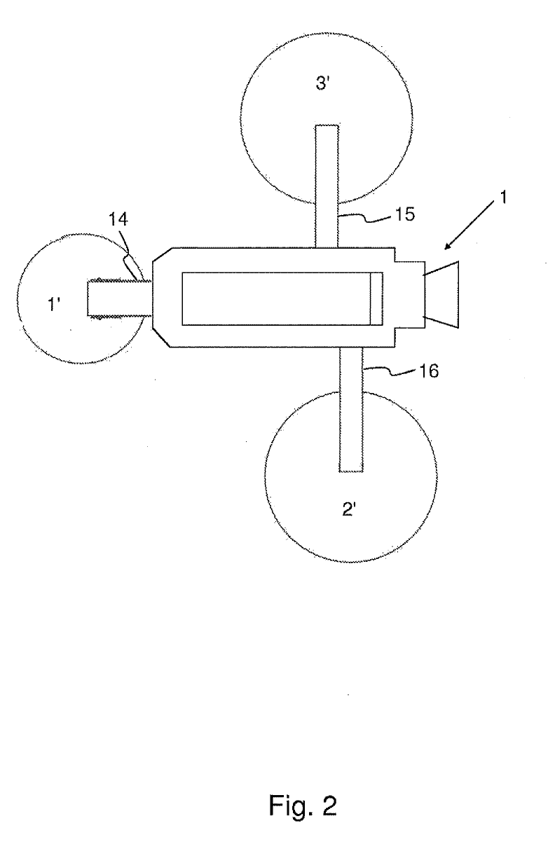

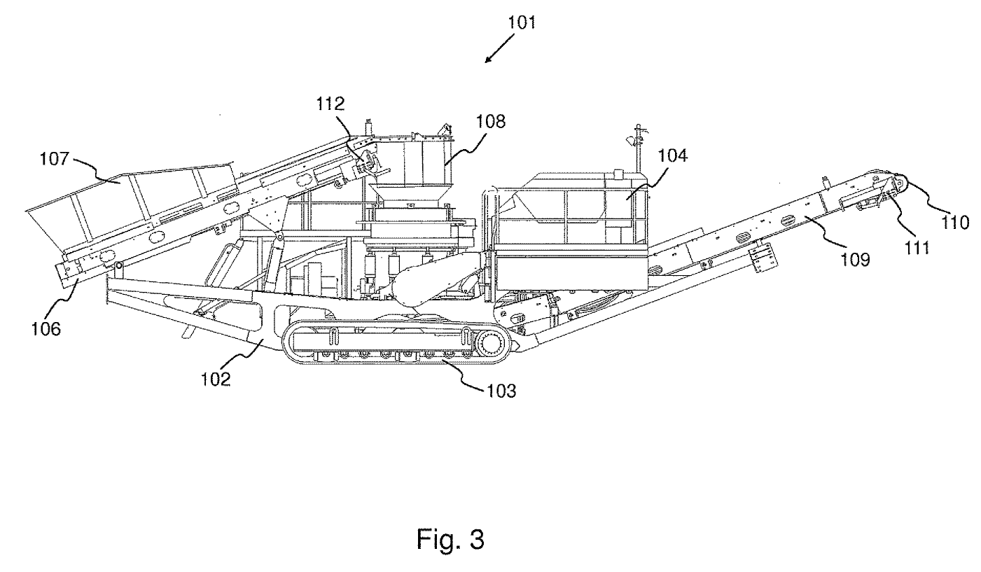

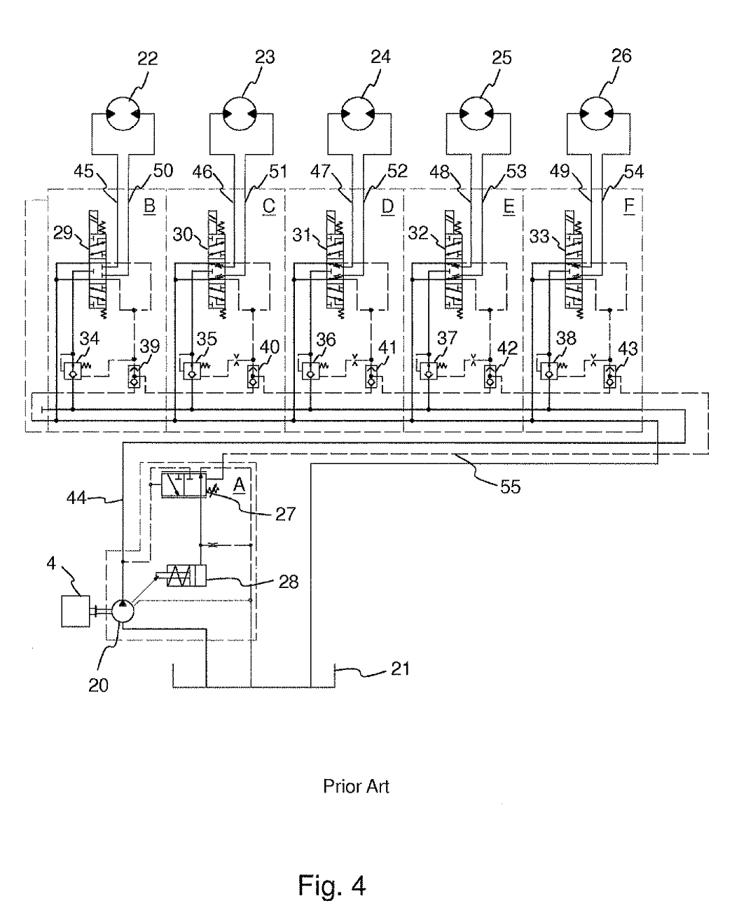

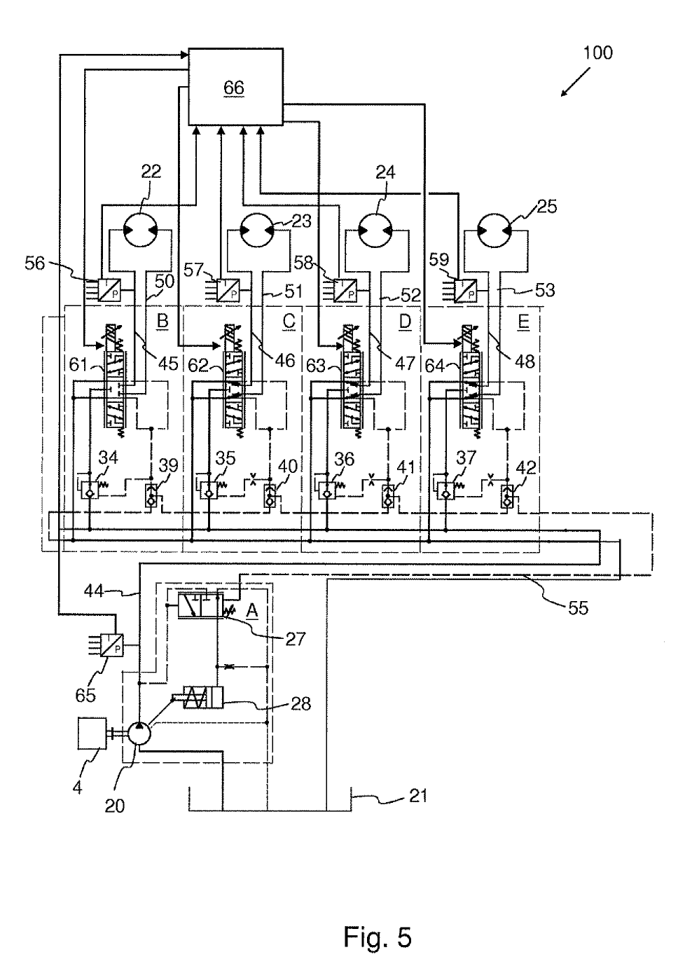

FIG. 5 shows a hydraulic transmission system 100 according to the invention. This embodiment shows a hydraulic transmission system for a processing plant, to which several conveyors are connected, the quantity of the material flow conveyed on the conveyors varying. The screening and/or crushing device and the other partial processes connected to it are substantially similar to those in the transmission system of prior art presented in connection with FIG. 4. The system according to this embodiment can be applied, for example, in a screening machine shown in FIGS. 1 and 2 or in a crushing machine shown in FIG. 3. The system is a load sensing system, to which four first motors 22-25 are connected, each driving the drawing drums of different conveyors of the processing plant. The system comprises parts that are similar to those in the system of prior art described in connection with FIG. 4, for which reason they will not be discussed in more detail in this context.

In the embodiment of FIG. 5, pressure sensors 56-59 are provided in the first actuator channel 45-48 of the directional valves of each first motor 22-25, after the first directional valves 61-64 in the direction of flow of the hydraulic fluid. The pressure sensors 56-59 measure the pressure prevailing in the channel and caused by the load of the conveyor. Furthermore, a pressure sensor 65 is installed in the pressure channel 44 of the directional valve, after the pump 20, to measure continuously the pressure produced by the pump 20. The pump 20 is adjusted to operate in the same way as in the solution of prior art, that is, the pump 20 transfers hydraulic fluid from the hydraulic fluid tank 21 via the pressure channel 44 of the directional valve to the first directional valves 61-64 and further via the first actuator channels 45-48 of the directional valves to the first motors 22-25. The pressure prevailing in the pressure channel 44 is adjusted to be about 15 to 30 bar higher than the pressure determined by the maximum load of the conveyors. If desired, the pressure sensors 56-49 can also be placed in the second actuator channel 50-53.

The first directional valves 61-64 in the directional valve blocks B-E of the first motors driving the conveyors are valves that can be adjusted by external control, such as proportional or servo valves. The directional valve blocks B-E also comprise pressure compensators 34-37 and shuttle valves 39-42. On the basis of the measurement results given by the pressure sensors 56-59, the directional valves 61-64 control continuously the volume flow of the hydraulic fluid flowing to the motors, and thereby the rotation speed of the conveyor. The pressure values measured by the pressure sensors 56-59 and 65 are transmitted to the control device 66 of the processing plant, which monitors the pressure levels. If the pressure of any of the first motors 22-25 rises, the control unit sends, if necessary, a control message to the respective directional valve which will adjust, or in this case increase the volume flow through the respective valve so that the speed of the respective conveyor is increased. In a corresponding manner, if the load of the conveyor is reduced, that is, the pressure is reduced, the control message transmitted by the control unit guides said directional valve to reduce the volume flow through it. Thus, the system is adjusted according to the conveyor charged with the heaviest load.

By means of the adjustment, it is possible to increase the volume flow of the conveyor having the heaviest load, and the volume flows of the other motors charged with a smaller load remain on the level required by their operation at the time. Thus, no conveyor is rotated at an unnecessarily high speed, and the pressure differences between the conveyors can be kept smaller and the power losses due to the pressure differences can be minimized.

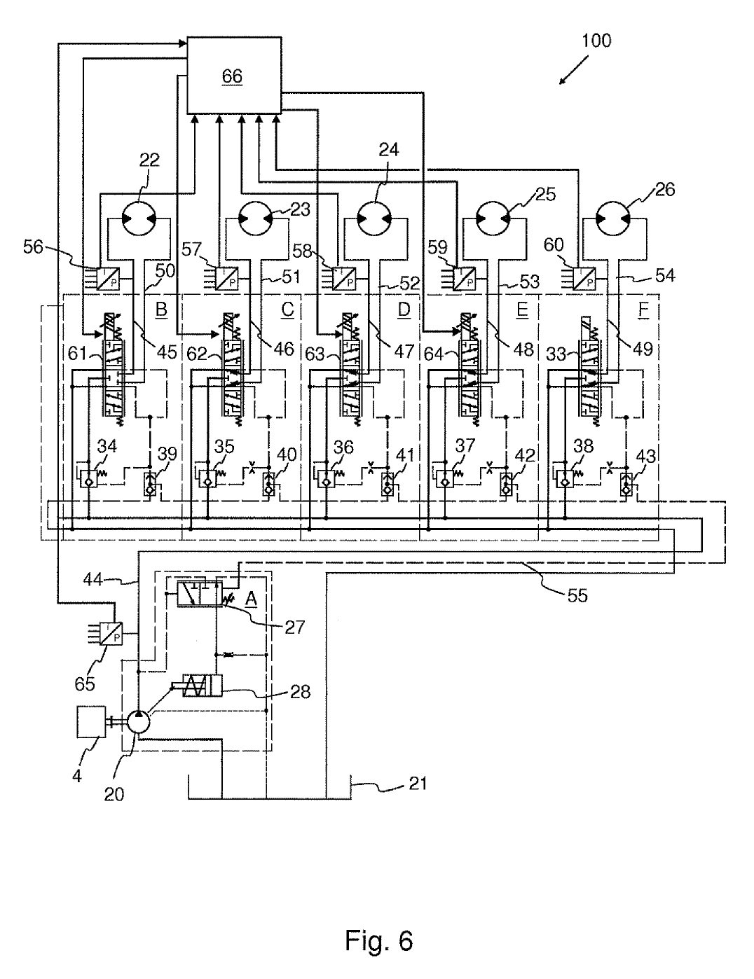

FIG. 6 shows another hydraulic transmission system 100 according to the invention. This embodiment shows a hydraulic transmission method for a screening machine, combined with a hydraulic motor of a screening machine unit rotating at a constant speed. The system is a load sensing system, to which are connected four first motors 22-25 driving the drawing drums of different conveyors of the screening machine, and a second motor 26, which is the hydraulic motor for the screening machine unit of the screen. The system comprises parts that are similar to those in the system of prior art described in connection with FIG. 3, for which reason they will not be discussed in more detail in this context.

Pressure sensors 56-60 are arranged in the first actuator channel 45-49 of the directional valves of each first motor 22-25 and the second motor 26, downstream of the first directional valves 61-64 and the second directional valve 33 in the direction of flow of the hydraulic fluid. They measure the pressure prevailing in the channel, caused by the load of the conveyor or the screening machine unit. Furthermore, the pressure caused by the pump 20 is measured by the pressure sensor 65 of the pressure channel. The pump 20 transfers hydraulic fluid via the pressure channel 44 of the directional valve to the first directional valves 61-64 and the second directional valve 33 and, from there, further via the first actuator channels 45-49 of the directional valves to the first motors and the second motor. Also in this embodiment, the pressure prevailing in the pressure channel 44 is adjusted to be about 15 to 30 bar higher than the pressure determined by the maximum load of the conveyors. If desired, the pressure sensors 56-60 can also be placed in the second actuator channel 50-54.

The first directional valves 61-64 in the directional valve blocks B-E are valves that can be adjusted by external control. On the basis of the measurement results given by the pressure sensors 56-60, they control continuously the volume flow of the hydraulic fluid flowing into the motors, and thereby the rotation speed of the conveyor. The pressure values measured by the sensors 56-60 and 65 are transmitted to the control device 66 of the screening machine which monitors the pressure values and, on the basis of them, transmits control messages to the first directional valves 61-64. The adjustment is made in the same way as described in connection with FIG. 5. The directional valve block F of the second motor 26 driving the screening machine unit comprises a second directional valve 33, a pressure compensator 38 and a shuttle valve 43. The second directional valve 33 is an on/off directional valve. It is also possible to use a proportional valve as the second directional valve.

In the simplest way, the speed of the second motor 26 driving the screening machine unit is set to a constant value, and the speed of the first motors 22-25 is adjusted according to the invention.

By means of the adjustment, it is possible to increase the volume flow of the conveyor having the heaviest load, and the volume flows of the other motors charged with a smaller load remain on the level required by their operation at the time. Thus, no conveyor is rotated at an unnecessarily high speed, and the pressure differences between the conveyors can be kept smaller and the power losses caused by the pressure differences can be minimized. It has been found by calculations that a considerable power saving is achieved by the transmission system according to the invention.

The invention is not intended to be limited to the embodiments presented as examples above, but the invention is intended to be applied widely within the scope of the inventive idea as defined in the appended claims.

The invention can thus be applied in controlling the transmission systems for mineral material processing plants equipped with any kind of hydraulic transmission. The number of conveyors for conveying the product types and other material flows in the screening or crushing machines may also vary. Preferably, the screening machine also comprises a crusher in addition to the screens.

The processing plant may be movable. However, the invention is not limited to any particular technology of transferring or moving a mobile mineral material processing apparatus. The apparatus can be mounted, for example, on runners, wheels or tracks. It can be moved by means of an external transfer device or it can be a self-propelled apparatus.

1-45. (canceled)

46. Hydraulic transmission system for a mineral material processing plant, wherein the transmission system comprises:
a hydraulic pump,
a power source for driving the pump,
at least one hydraulic first motor for driving at least one conveyor to the mineral material processing plant,
at least one first directional valve connected via a first actuator channel to the first motor,
wherein the pump is arranged to transfer hydraulic fluid from a hydraulic fluid tank via a pressure channel to the first directional valve and further from the first directional valve via the first actuator channel to the first motor,
wherein the first directional valve is configured, by external control during the running of the processing plant, to adjust continuously the volume flow of the hydraulic fluid in the first actuator channel, and
wherein the transmission system further comprises a pressure sensor arranged to measure the pressure of the hydraulic fluid in the first actuator channel and representing load experienced by the first motor while conveying material, and
wherein the first directional valve is arranged to adjust the volume flow of the hydraulic fluid entering the first motor in the first actuator channel on the basis of the pressure of the hydraulic fluid measured by the pressure sensor, and
wherein the transmission system further comprises a control device to which the pressure of the hydraulic fluid measured by the pressure sensor is arranged to be transmitted, wherein the control device is configured to determine a volume flow control command to be transmitted to the first directional valve and to transmit the determined volume flow control command to the first directional valve,
such that the first directional valve increases the volume flow of the first actuator channel on the basis of rising pressure of the first actuator channel such that the speed of the first motor and the conveyor increases, and
such that the first directional valve decreases the volume flow of the first actuator channel on the basis of dropping pressure of the first actuator channel such that the speed of the first motor and the conveyor decreases.

47. The power transmission system according to claim 46, wherein the transmission system further comprises:
a pump/control block comprising the hydraulic pump, a pressure difference regulator, and a cylinder,
wherein the cylinder is arranged to adjust the volume flow of the pump to a value determined by the pressure difference regulator.

48. The transmission system according to claim 47, wherein the pressure difference regulator is arranged to adjust the pressure of the hydraulic fluid produced by the pump in the pressure channel to a pressure determined by the maximum load of the conveyors.

49. The transmission system according to claim 46, wherein the mineral material processing plant is a screening machine.

50. The transmission system according to claim 49, wherein the transmission system further comprises:
a hydraulic second motor for driving a screening machine unit connected to the screening machine, and
a second directional valve connected via an additional actuator channel to the second motor,
wherein the pump is arranged to transfer hydraulic fluid from the hydraulic fluid tank via the pressure channel to the second directional valve and further from the second directional valve via the additional actuator channel to the second motor, and
wherein the transmission system further comprises a pressure sensor arranged to measure the pressure of the hydraulic fluid in the additional actuator channel and representing load experienced by the screening machine unit while screening.

51. The transmission system according to claim 50, wherein the measured pressure of the hydraulic fluid is the pressure determined by the maximum load of the screening machine unit.

52. The transmission system according to claim 50, wherein the rotation speed of the second motor is set to be constant.

53. The transmission system according to claim 50, wherein the second directional valve is an on/off directional valve.

54. The transmission system according to claim 46, wherein the first directional valve is a proportional valve.

55. The transmission system according to claim 46, wherein the first directional valve is arranged to control continuously the volume flow of the hydraulic fluid supplied to the first motor, wherein the volume flow of the first directional valve is arranged to control the speed of rotation of a drawing drum driving the conveyor.

56. The transmission system according to claim 46, wherein the conveyor is a product type conveyor.

57. The transmission system according to claim 46, wherein the conveyor is a recirculation conveyor.

58. The transmission system according to claim 46, wherein the transmission system further comprises a feed conveyor.

59. The transmission system according to claim 46, wherein the mineral material processing plant comprises a crushing machine.

60. A method for controlling the hydraulic transmission system of a mineral material processing plant, wherein the transmission system comprises:
a hydraulic pump,
a power source for driving the pump,
at least one hydraulic first motor for driving at least one conveyor belonging to the mineral material processing plant,
at least one first directional valve connected via a first actuator channel to the first motor,
the method comprising:
transferring, by means of the pump, hydraulic fluid from a hydraulic fluid tank via a pressure channel to the first directional valve and further from the first directional valve via the first actuator channel to the first motor,
wherein the first directional valve is configured, by external control during the running of the processing plant, to adjust continuously the volume flow of the hydraulic fluid in the first actuator channel, and
wherein the method further comprises the following steps:
measuring, by means of a pressure sensor, the pressure of the hydraulic fluid in the first actuator channel and representing load experienced by the first motor while conveying material, and
controlling, by means of the first directional valve, the volume flow of the hydraulic fluid supplied to the first motor in the first actuator channel on the basis of the pressure of the hydraulic fluid measured by the pressure sensor, and
increasing, by means of the first directional valve, the volume flow of the first actuator channel on the basis of rising pressure of the first actuator channel such that the speed of the first motor and the conveyor increases, and
decreasing, by means of the first directional valve, the volume flow of the first actuator channel on the basis of dropping pressure of the first actuator channel such that the speed of the first motor and the conveyor decreases.

61. The method according to claim 60, wherein:
transmitting the pressure of the hydraulic fluid measured by the pressure sensor to a control device,
determining, by means of the control device, a volume flow control command to be transmitted to the first directional valve, and
transmitting the determined volume flow command to the first directional valve.

62. The method according to claim 60, wherein:
controlling, by means of a pressure difference regulator, the pressure of the hydraulic fluid produced by the pump in the pressure channel to a pressure determined by the maximum load of the conveyors.

63. The method according to claim 62, wherein:
adjusting, by means of a cylinder, the volume flow of the pump to a value determined by the pressure difference regulator.

64. The method according to claim 60, wherein the mineral material processing plant comprises a screening machine.

65. The method according to claim 64, wherein the transmission system further comprises:
a hydraulic second motor for driving a screening machine unit connected to the screening machine, and
a second directional valve connected via an additional actuator channel to a second motor,
wherein the method further comprises the following step:
transferring, by means of the pump, hydraulic fluid from a hydraulic fluid tank via the pressure channel to the second directional valve and further from the second directional valve via the additional actuator channel to the second motor, and
measuring, by means of a pressure sensor, the pressure of the hydraulic fluid in the additional actuator channel and representing load experienced by the screening machine unit while screening.

66. The method according to claim 65, wherein:
adjusting the pressure of the hydraulic fluid to the pressure determined by the maximum load of the screening machine unit.

67. The method according to claim 65, wherein:
setting the rotation speed of the second motor constant.

68. The method according to claim 65, wherein the second directional valve is an on/off directional valve.

69. The method according to claim 60, wherein the first directional valve is a proportional valve.

70. The method according to claim 60, wherein:
adjusting the volume flow of the hydraulic fluid supplied to the first motor by means of the first directional valve, and
adjusting the speed of rotation of a drawing drum driving the conveyor by means of the volume flow of the first directional valve.

71. The method according to claim 60, wherein the conveyor is a product type conveyor.

72. The method according to claim 60, wherein the conveyor is a recirculation conveyor.

73. The method according to claim 60, wherein the transmission system further comprises a feed conveyor.

74. The method according to claim 60, wherein the mineral material processing plant comprises a crushing machine.

75. A screening machine comprising
a frame,
at least one screen mounted on the frame and comprising at least two screen decks for screening of material,
conveyors for conveying material types separated by the screen,
a screening machine unit for moving the screen,
a transmission system, which transmission system comprises
a hydraulic pump,
a power source for driving the pump,
at least one hydraulic first motor for driving at least one conveyor belonging to the screening machine,
a second hydraulic motor arranged to drive a screening machine unit connected to the screening machine,
at least one first directional valve connected via a first actuator channel to the first motor, and
a second directional valve connected via an additional actuator channel to the second motor,
wherein the pump is arranged to transfer hydraulic fluid from a hydraulic fluid tank via a pressure channel to the first directional valve and the second directional valve and further via the first actuator channel and the additional actuator channel to the first and second motors,
wherein the first directional valve is configured, by external control during the running of the processing plant, to adjust continuously the volume flow of the hydraulic fluid in the first actuator channel, and
wherein the transmission system further comprises a pressure sensor arranged to measure the pressure in the first actuator channel and representing load experienced by the first motor while conveying material, and
wherein the first directional valve is arranged to adjust the volume flow of the hydraulic fluid supplied to the first motor in the first actuator channel on the basis of the pressure of the hydraulic fluid measured by the pressure sensor, and
wherein the transmission system further comprises a control device to which the pressure of the hydraulic fluid measured by the pressure sensor is arranged to be transmitted, wherein the control device is configured to determine a volume flow control command to be transmitted to the first directional valve and to transmit the determined volume flow control command to the first directional valve,
such that the first directional valve increases the volume flow of the first actuator channel on the basis of rising pressure of the first actuator channel such that the speed of the first motor and the conveyor increases, and
such that the first directional valve decreases the volume flow of the first actuator channel on the basis of dropping pressure of the first actuator channel such that the speed of the first motor and the conveyor decreases.

76. The screening machine according to claim 75, wherein the transmission system further comprises:
a pump/control block comprising the hydraulic pump, a pressure difference regulator, and a cylinder,
wherein the cylinder is arranged to adjust the volume flow of the pump to a value determined by the pressure difference regulator.

77. The screening machine according to claim 76, wherein the pressure difference regulator is arranged to adjust the pressure of the hydraulic fluid produced by the pump in the pressure channel to a pressure determined by the maximum load of the conveyors or the screening machine unit.

78. The screening machine according to claim 75, wherein the conveyor is a product type conveyor arranged to convey product types separated by the screen.

79. The screening machine according to claim 75, wherein the conveyor is a recirculation conveyor arranged to convey a product type to be recirculated onto the screen.

80. The screening machine according to claim 75, wherein the screening machine comprises a crusher for reducing the particle size of the material fed into the crusher.

81. The screening machine according to claim 75, wherein the screening machine comprises means connected to the frame for moving the screening machine.

82. A crushing machine comprising
a frame,
at least one crusher mounted on the frame for reducing the particle size of material,
at least one conveyor for conveying material to be crushed to the crusher,
at least one conveyor for conveying material produced by the crusher,
a transmission system, which transmission system comprises:
a hydraulic pump,
a power source for driving the pump,
at least one hydraulic first motor for driving at least one conveyor belonging to the crushing machine,
at least one first directional valve connected via a first actuator channel to the first motors,
wherein the pump is arranged to transfer hydraulic fluid from a hydraulic fluid tank via a pressure channel to the first directional valve and further from the first directional valve via the first actuator channel to the first motor,
wherein the first directional valve is configured, by external control during the running of the processing plant, to adjust continuously the volume flow of the hydraulic fluid in the first actuator channel, and
wherein the system further comprises a pressure sensor arranged to measure the pressure of the hydraulic fluid from the first actuator channel and representing load experienced by the first motor while conveying material, and
wherein the first directional valve is arranged to adjust the volume flow of the hydraulic fluid entering the first motor in the first actuator channel on the basis of the pressure of the hydraulic fluid measured by the pressure sensor, and
wherein the transmission system further comprises a control device to which the pressure of the hydraulic fluid measured by the pressure sensor is arranged to be transmitted, wherein the control device is configured to determine a volume flow control command to be transmitted to the first directional valve and to transmit the determined volume flow control command to the first directional valve,
such that the first directional valve increases the volume flow of the first actuator channel on the basis of rising pressure of the first actuator channel such that the speed of the first motor and the conveyor increases, and
such that the first directional valve decreases the volume flow of the first actuator channel on the basis of dropping pressure of the first actuator channel such that the speed of the first motor and the conveyor decreases.

84. The crushing machine according to claim 82, wherein the transmission system further comprises:
a pump/control block comprising the hydraulic pump, a pressure difference regulator, and a cylinder,
wherein the cylinder is arranged to adjust the volume flow of the pump to a value determined by the pressure difference regulator.

85. The crushing machine according to claim 84, wherein the pressure difference regulator is arranged to control the pressure of the hydraulic fluid produced by the pump in the pressure channel to a pressure determined by the maximum load of the conveyors.

86. The crushing machine according to claim 84, wherein the conveyor for conveying material produced by the crusher is a product type conveyor arranged to convey product types produced by the crusher.

87. The crushing machine according to claim 82, wherein the conveyor for conveying material to be crushed to the crusher is a feed conveyor arranged to convey material to be fed into the crusher.

88. The crushing machine according to claim 82, wherein the crushing machine comprises means mounted on the frame for moving the crushing machine.
